(19) United States
(12) Patent Application Publication
(10) Pub. No.: US 2015/0207626 A1
(43) Pub. Date: Jul. 23, 2015

(54) COMMUNICATION SECURED BETWEEN A MEDICAL DEVICE AND ITS REMOTE CONTROL DEVICE

(71) Applicant: DEBIOTECH S.A., Lausanne (CH)

(72) Inventors: Frédéric Neftel, Lausanne (CH); Christian Grigis, Lausanne (CH); Pascal Bauermeister, Lausanne (CH); Stephan Proennecke, Lausanne (CH)

(21) Appl. No.: 14/413,857

(22) PCT Filed: Jul. 9, 2013
(86) PCT No.: PCT/IB2013/055626

§ 371 Date: Jan. 9, 2015

(30) Foreign Application Priority Data
Jul. 9, 2012 (EP) 12175498.0

(51) Int. Cl. H04L 9/30; H04L 29/06

(52) U.S. Cl. CPC H04L 9/30; H04L 63/0435; H04L 63/0442; H04L 2209/80

(57) ABSTRACT

The invention comprises a medical assembly composed by a medical device and a remote control which communicate in a secure and wireless manner. The remote control is connected to at least one security token. Key information stored in the medical device and the security token is used to establish a connection and to communicate in a secure manner.

### FIELD OF INVENTION

The present invention relates to the remote control of a medical device such as but not limited to a delivery device (e.g. insulin pump) and/or a wireless sensor (e.g. continuous glucose meter) and/or an implantable device and/or a sampling device.

### STATE OF THE ART

A remote control is required for controlling some medical devices like an insulin pump that is light and small like a patch pump, because it could be very difficult for the patient to see the content of a display that would be located on the pump itself. Most of the pumps today use a dedicated proprietary remote control, which represents another device to carry with all the disadvantages that it could generate like:
To find a pocket to put it in a safe place with a fast and easy access.
To not forget your remote control
To think about charging it or to have spare batteries
To prevent its deterioration due to a fall or any “bad” external condition, like exposure to the sun or to sand.

One way to prevent the use of another specific device is to integrate the remote control functionality into an existing device that the patient should already carry with him, such as but not limited to blood glucose meter or a cell phone, which would have all the capabilities required for integrating the remote control features.

Using a cell phone for this purpose is very attractive but brings many security aspects that must be addressed before allowing its use for programming an insulin pump. Among the important security features that must be ensured are:
Integrity of the data that are displayed to the user
Integrity of the commands that are sent to the insulin pump
Integrity and protection of the databases, which store the therapeutic parameters of the patient and the logs of the infusion history and the events.
Pairing securely the medical device with its remote control.
Responsiveness of the software at any time (e.g.: raising an alarm while another software has the focus, ability to process user requests while other tasks are overloading the resources like the MCU, etc.).

To secure a wireless communication, the devices of the state of the art use authentication process where the devices share a secret in a non-secure or insufficiently secure manner. The authentication process can use a smart card like used in the cell phone, and the US patent applications (US 2010/045425, US 2005/204134, US 2008/140160 and US 2011/197067) disclose medical devices which comprise a token used as a trusted third party and/or used for an authenticating process. In particular, said token is used to certificate that the patient who has a token is the patient who has an associated medical device. Furthermore, all of said products exchange their encryption key and/or uses a standard pairing process in such a way that a hacker can find data to manage the medical device.

### GENERAL DESCRIPTION OF THE INVENTION

The present application claims the benefit of the priority of PCT/IB2012/055917 filed on Oct. 26, 2012 in the name of Debiotech and the priority of EP 12175498.0 filed on Jul. 9, 2012 in the name of Debiotech, the entire disclosure of which is incorporated herein by reference.

The purpose of the invention is to offer a robust environment for securing the communication between a medical device and its remote control. In the present document, the expression “to secure the communication” has to be understood as all means used to ensure:
the data exchange between the remote control and the medical device is correct and/or
said data has been sent by an authorized operator (e.g. the patient also called the user) and/or
the used devices are the correct devices and/or
said data have been correctly received.

So to secure the communication, said means can check the integrity of the data or the application or operating system and/or encrypt the data and/or pair securely, and/or check the identity of the operator, . . . . To this effect, the invention comprises an medical assembly composed by a medical device and a remote control, wherein said secure means may be:
an additional microcontroller (MCU) inserted into (alternately plugged in) the remote control,
a virtualization platform which may be incorporated in the remote control or an additional microcontroller belonging to the medical device,
a specific loopback process,
a method to check integrity,
a specific pairing process,
a method to generate and/or share a secret
   The use of said distinct means permits to improve in a substantial way the security, but it's also possible to use just one or two of said means.

Said remote control can be used to manage and/or monitor at least one medical device such as but not limited to a delivery device and/or a wireless sensor and/or an implantable device and/or a sampling device and/or a blood glucose monitoring, . . . . In preference, the design of said remote control allows to be easily transportable and may be light, mobile, wearable in a pocket, . . . .

Said medical device comprises communication means permitting a wireless communication with said remote control, an internal memory which contains the key information to establish and/or secure said communication. In preference, said medical device is paired with only one microcontroller (MCU) which comprises a memory which also contains said key information (e. g. link key, encryption key, hash . . . ). Said MCU is designed to be plugged in a remote control. In this document, “plug in” can be replaced by “insert into” or “connected to”. The communication between the remote control and the MCU may be performed by wireless connection or wired connection, with or without contact.

So, the medical assembly uses a MCU which can be plugged in a remote control. Said assembly suitable for establishing a secured communication between a medical device and a remote control comprises:
A remote control which comprises:
   Communication means for allowing a wireless communication with said medical device,
   Connecting means for plugging an additional microcontroller (MCU);
   A display means (optionally),
   At least one input means,
   At least one processor which is connected to the communication means, the connecting means, the input means and the optional display means and;
A medical device which comprises:
   Communication means for allowing a wireless communication with said remote control,
   A memory;
A MCU designed to be connected to said remote control; said MCU further may comprise a memory;

The memory of said medical device and the memory of said MCU contain at least a part of the key information to establish and/or secure the communication. Said key information contains at least a part of a shared secret. At least one medical device is exclusively paired with only one MCU. In one embodiment, the pairing between the medical device and the MCU is paired prior to use by a patient.

In one embodiment, the connection between the MCU and the remote control is performed by a wireless communication.

In the present document, a microcontroller (MCU) may be an integrated chip which is inserted into the remote control or an external device which is plugged in the remote control. Typically, a MCU includes a CPU, RAM, some form of ROM, I/O ports, and timers. Unlike a computer or a remote control, which includes other components, a microcontroller (MCU) is designed for very specific tasks, for example to control a particular system. As a result, the MCU can be simplified and reduced, which cuts down on production costs. The MCU may also integrates specific features for protecting its memory content, like tamper-evident seals, locks, tamper response and zeroization switches. Moreover, said MCU doesn't bring another CPU and memories which the OS (of the remote control) could use to improve the performance of the remote control but it brings other functionalities in particular more securities, in particular at least a part of the shared secret generated by the pairing process or other process. The MCU and the CPU of the remote control are different and have different tasks. In this invention, the MCU is fully independent from the remote control in such a way the MCU may be used with different remote controls. Said MCU can be a Smart card, Sim card, SD Card such as SDIO card (Secure Digital Input Output), an internal or external dongle . . . . In this document, we can use indifferently the following terms: external or internal microcontroller, additional microcontroller or MCU.

In one embodiment, said medical device and said MCU comprise memories containing the wireless communication configuration (link key, address of the medical device (e.g. Bluetooth address), . . . ). In such a way, said device and said MCU know in advance the suitable configuration. In particular, said MCU may contain the key information used to connect the remote control to the medical device and to protect said communication (e.g. the link key, . . . ) in such a way that it does not need to be provided in an unsecured way (e.g. via Bluetooth) or that the user (e.g. the patient) does not must perform specific tasks for pairing the remote control with the medical device.

In preference, a medical device is paired with only one MCU and said MCU is inserted into a remote control; In such a way, only the remote control containing said MCU can manage and/or monitor said medical device. Also, the patient can change remote control while knowing that the remote control, in which said MCU is inserted, is the single remote control that can manage and/or monitor the medical device.

In one embodiment, the remote control manages and/or monitors at least two medical devices. In this case, said medical devices may be paired with only one MCU, alternatively each medical device is paired with its own MCU.

In one embodiment, said MCU contains the key information (patient identifier, identifier and address of the medical server, encryption key, . . . ) to connect said medical assembly with a medical server. In this embodiment, the medical assembly may use the data communication means of the remote control to send a receive data to the medical server. Thus, said MCU may contain all information to establish and to secure the communication between one or more medical devices and/or the medical server such as but not limited to the user authentication, the encryption parameters, . . . .

In one embodiment, the MCU may store in its memory at least a set of data sent by the medical device or other set of data provided from a remote device or other devices. In another embodiment, said data are encrypted and stored in the remote device or medical device but only the MCU (or medical device) contains the key to decrypt said data.

For added security, said key information is generated by the manufacturer, doctor, caregiver or pharmacist and is recorded in said memories prior to use by the patient.

In one embodiment in which remote control uses a virtual platform, the remote control incorporates a virtualization platform comprising:
a host operating system (hOS) emulating hardware components for at least one guest operating system (gOS),
a first gOS handling common functions such as but not limited to calendar or contacts, all those common functions being designed to be used in an uncontrolled environment,
a medical operating system (mOS) handling remote control functions for a medical device, all those remote control functions being designed to be used in a controlled environment. Said mOS may be a specific gOS.

In the present document, the expression “host operating system” has to be understood as an operating system as thin as possible such as an enhanced hypervisor which is alone to manage and to share all remote control peripherals such as RAM, Flash, UART, Wifi, . . . . The hOS doesn't handle common functions, its purpose is to secure the commands sent to the medical device.

In one embodiment, a MCU (like discovered above) is plugged in the remote control, but said hOS does not necessarily manage and share the peripherals of said MCU. In one embodiment, the MCU contains means or data for check the integrity of each operating system.

In the present document, the expression “guest operating system” has to be understood as a standard operating system (such as but not limited to Android, iOS from Apple, . . . ) which handles the common functions (phoning, sending data, calendar, . . . ) or a specific operating system (such as a medical operating system). Said distinct guest operating systems may co-exist on the same remote control in strong isolation from each other.

In the present document, the expression “controlled environment” has to be understood as a space where:
the responsiveness of the intended application is deterministic
the list and version of the software packages and the operating system are known and can't be changed by the users
the access to the hardware components is controlled and guaranteed
the responsiveness of the hardware components (CPU, memory, RF link, etc) is deterministic
a predefined minimum bandwidth is always guaranteed to access hardware components (eg: CPU, network RF link, etc)
at least one medical application and/or mOS is run and stored
   The controlled and uncontrolled environments are totally isolated.

In a preferred embodiment, said hOS is more than a standard hypervisor. Said hOS, although being as thin as possible, contains some operating process(es) to deny some application (running in the uncontrolled environment or controlled environment) or give some priorities to the medical OS. So, the hOS can stop all or part of applications which are running in the uncontrolled environment when the controlled environment is launched or when all or part application of the controlled environment is running. For example, the hOS displays only medical application even if the phone received a message.

As a consequence, the uncontrolled environment has no visibility on the interactions between the hardware and the controlled environment. Advantageously, the guest operating system or the applications which are in the controlled environment (such as but not limited to the medical operating system and/or the medical application) has priority over another. Thereby, the host operating system decides to block an application running in the uncontrolled environment in order to avoid any perturbation caused by this application. The host operating system may also decide which application from the controlled or the uncontrolled environment will take the focus on the screen.

In one embodiment, the remote control according to the invention is a cell phone (e.g. a smart phone). Any suitable OS can be used, for instance Android. The remote control is used in combination with a medical device. Advantageously, the remote control functions are designed for the remote control of an insulin pump.

As described above, said MCU may also be used to authenticate or to ensure the integrity of hOs or to store the list of applications which have the priority over another (or vice versa) or to store the different scenarios to execute when some application is running or not, or certain condition are fulfilled . . . .

In another embodiment of a medical assembly, said assembly advantageously comprises a loopback mechanism between at least two objects (e.g. insulin pump and remote control). The general concept of loopback is a mechanism through which a message or signal ends up (or loops) back to where it started.

In the present document, the loopback mechanism isn't a simple confirmation of the data entered by the user. For example, the standard loopback mechanism is used by a device which ask to the user if it confirms the command. In this standard case, the loopback is between the user and the device.

The new loopback mechanism permits to confirm the data sent by the remote control and received by the medical device. So, the user enters the command in the remote (with the input means) and the remote control sends it to the medical device via a secured communication. Thanks to said mechanism, before launched the command, the medical device has to ask a confirmation if the received command is the command sent by the user. The medical device send to the remote control a data which is displayed by the remote control. Said data may be a challenge or an encrypted data or other. When, the user confirms to the medical device, the command is launched. Advantageously, to improve the security, the user has to enter a PIN Code to confirm the command.

The security of the loopback mechanism and the connectivity to the medical device can be advantageously protected by using an additional protected MCU into the remote control, like a smart card or a SIM or SD Card . . . where, the MCU may encrypt or decrypt the data for the loopback.

The remote control or the MCU (e.g. an external dongle) or medical device may comprise an additional means for sending information to the patient in a secure manner (for instance: LED, vibrator, display means, . . . ). For example, an external MCU may display the data in its own display means.

The present invention offers at least one of the following advantages:
The invention also provides a controlled environment in which the responsiveness, the integrity and the security are ensured by the core design of the low level operating system architecture.
The proposed solution provides a secured environment, which may for instance prevent any unwanted application that could mimic the normal use by changing the therapy, like programming several additional infusions not wanted by the patient.
Using a MCU, which is independent of remote control as a smart card, permits to connect automatically and securely the remote control with the medical device without to be visible by another device during the pairing process.
Using a MCU, which may be inserted into or plugged in different remote controls like a cell phone, permits to change of remote control in case of problem (low battery, forgetting or losing the remote control, . . . ). In this case, user may keep her medical device and get a secure access to it via the new remote control, and MCU can ensure the privacy of the data recorded into the remote control memory.
Using a loopback process permits to ensure that the value programmed in the medical device (for instance an insulin pump) corresponds to the value expected by the user on the remote control.
At the end of the loopback process, the user acknowledges the value preferably by entering a PIN code (which only the user knows) on the remote control. Using said PIN code ensures the confirmation is approved by the correct user.
Using the virtual platform ensures the medical application or mOS is priority and securely run.
The hOS ensures some peripherals (MCU, LED, part of the screen, vibrator, . . . ) are only used by the medical application and/or mOS.

### LIST OF FIGURES

The invention is discussed below in a more detailed way with examples illustrated by the following figures:

FIG. 1 shows the display of a remote control (3) according to the invention, which includes a virtualization platform.

FIG. 2 shows the overall architecture of a preferred embodiment of the invention, namely an assembly comprising a remote control (3) and a medical device (1).

FIG. 3 illustrates a loopback mechanism according to the invention

FIG. 4 illustrates a loopback mechanism according to the invention using a MCU.

FIG. 5 shows a medical device (1) communicating with a remote control (3) which comprises inside a MCU such as a Smart Card (4)

FIG. 6 shows a medical device (1) communicating with a remote control (3) plugged to an MCU (6)

FIG. 7 shows a medical device (1) communicating with a remote control (3) plugged to an MCU (6) which comprises inside another MCU such as a Smart Card (4)

FIG. 8 shows two medical devices (1, 7) communicating with a remote control (3) plugged to an MCU (6) which comprises inside two MCU such as Smart Cards (4a, 4b)

FIG. 9 shows two medical devices (1, 7) communicating with a remote control (3) which comprises inside two MCU such as Smart Cards (4a, 4b)

FIG. 10 shows two medical devices (1, 7) communicating with a remote control (3) which comprises inside a single MCU such as a Smart Card (4c)

FIG. 11 shows the contained of the MCU (8).

FIG. 12 shows two medical devices (1, 7) communicating with a remote control (3) plugged to an external MCU (6) which comprises inside another MCU such as Smart Cards (4b)

FIG. 13 shows a pairing device (16)

FIG. 14 shows at least one secret may be shared.

FIG. 15 shows an external MCU (6) deconnectable and usable as small remote control.

FIG. 16 shows remote control (3) comprising a first display means (18) and at least one secured display means (19).

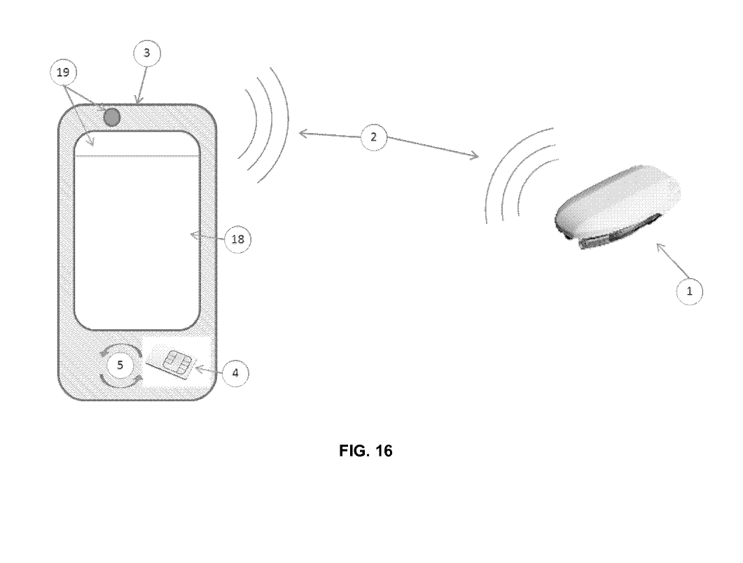

FIG. 17 illustrates a session key generation according to the invention

### LIST OF COMPONENTS

1 a medical device

2 wireless communication

3 remote control

4, 4a, 4b, 4c a microcontroller (such as a smart car)

5 secured processing means

6 an external MCU

7 another medical device

8 a microcontroller

9 CPU

10 Memory of the microcontroller

11 first part of the memory

12 second part of the memory

13 third part of the memory

14 fourth part of the memory

15 other means or features of the external MCU

16 a pairing device (16)

17 Connecting means

18 first display means

19 second or secure display means (LED, . . . )

### DETAILED DESCRIPTION OF THE INVENTION

In the following detailed description, reference is made to the accompanying drawings that form a part hereof, and in which are shown by way of illustration several embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used herein, “have”, “having”, “include”, “including”, “comprise”, “comprising” or the like are used in their open ended sense, and generally mean “including, but not limited to.

As used in this specification and the appended claims, the term “or” is generally employed in its sense including “and/or” unless the content clearly dictates otherwise.

As used in this specification and the appended claims, the term “node” may be employed to replace the following terms: medical device, medical server, BGM (Bloog Glucose Meter), CGM (Continuous Glucose Monitor), remote control, cell phone, . . . .

As used in this specification and the appended claims, the term “MCU” may be used to reference to the following terms: dongle, internal MCU or external MCU.

The invention is set forth and characterized in the independent claims, while the dependent claims describe other characteristics of the invention.

### Features of the Additional Microcontroller (MCU)

In a preferred embodiment, a medical assembly suitable for establishing and for securing a communication between a medical device (1, 7) and a remote control (3), said medical assembly comprises:
A remote control (3) which comprises:
   Communication means for allowing a wireless communication (2) with said medical device (1, 7),
   Connecting means for plugging an additional microcontroller (MCU) (4, 6, 8); p2 A display means (optionally),
   At least one input means,
   At least one processor which is connected to the communication means, the connecting means, the input means and the optional display means and;
A medical device (1, 7) which comprises:
   Communication means for allowing a wireless communication (2) with said remote control (3),
   A memory;
A MCU (4, 6, 8) designed to be connected to said remote control (3); said MCU (4, 6, 8) further comprises a memory;
   The memory of said medical device (1, 7) and the memory of said MCU (4, 6, 8) contain the key information to establish and to secure the communication.

Said medical device (1, 7) may be a delivery device (such as but not limited to an insulin pump) and/or a wireless sensor (which may measure physiological properties of the patient.) and/or an implantable device and/or a sampling device.

In one embodiment, at least one medical device (1, 7) is exclusively paired with only one MCU (4, 6, 8). Said key information may be stored all or part in a secure memory of the medical device and/or MCU. In one embodiment, the MCU is paired only once in such a way that the MCU cannot be paired with another medical device.

Said remote control may be a phone, a blood glucose meter or other portable device which comprises a connecting means for plugging-in said MCU.

The processor of the remote control (3) is the main computing unit of the remote control. It is the one running the remote control operating system (OS) (or operating systemes OSes), and has access to all the remote control (3) peripherals such as RAM, Flash, UART, Wifi, etc.

The MCU (4, 4a, 4b, 4c, 6, 8) contains also a processor as well, which runs its own operating system and code. That processor has access to the internal peripherals of the MCU (4, 4a, 4b, 4c, 6, 8) (crypto engine, communication interface, Key generator, etc.). The processor of the MCU (4, 4a, 4b, 4c, 6, 8) may have no access to all or part of peripherals of the remote control (3). The only interaction between the two devices (MCU (4, 4a, 4b, 4c, 6, 8) and remote control (3)) is via a communication link to exchange data. The processor of the remote control (3) and the processor of the MCU (4, 4a, 4b, 4c, 6, 8) are independent of each other. The remote control (3) may have a limited access or no access to the data stored in the MCU. Thus, said MCU (4, 4a, 4b, 4c, 6, 8) can be plugged in distinct remote control and ensure a total security.

Said MCU (4, 4a, 4b, 4c, 6, 8) may be an Universal Integrated Circuit Card (like a Smart Card, a SIM Card, SD Card, SDIO card, . . . ) or other external device which is designed to be plugged or inserted into the remote control or at least connected to the connecting means of the remote control (3).

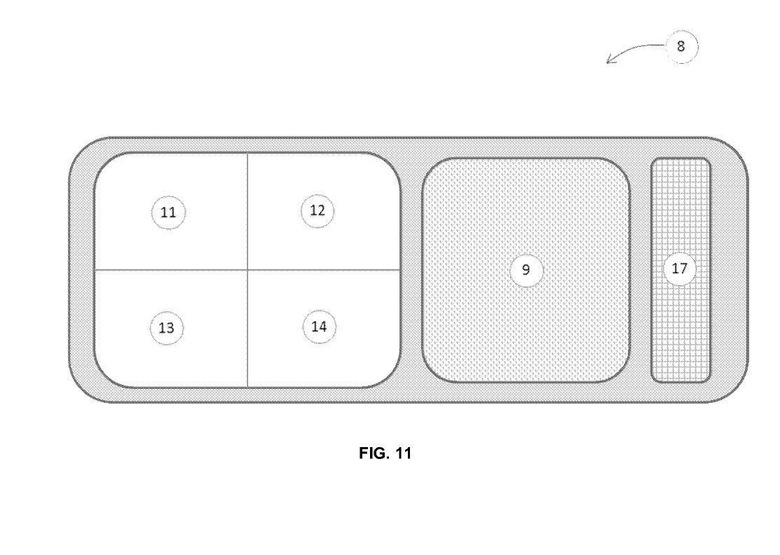

In one embodiment disclosed in FIG. 11, the MCU (4, 4a, 4b, 4c, 6, 8) comprises a Central Processing Unit (CPU) (9), connecting means (17) designed to be connected to the remote control and at least one memory (10) which may contain several, e.g. four distinct parts:
A first part (11) which is writable and readable by the CPU and other device (eg the remote control in which the MCU is plugged),
A second part (12) which is writable and readable by the CPU but writable and unreadable by other device,
A third part (13) which is writable and readable by the CPU but unwritable and readable by other device, and
A fourth part (14) which is writable and readable by the CPU but unwritable and unreadable by other device.

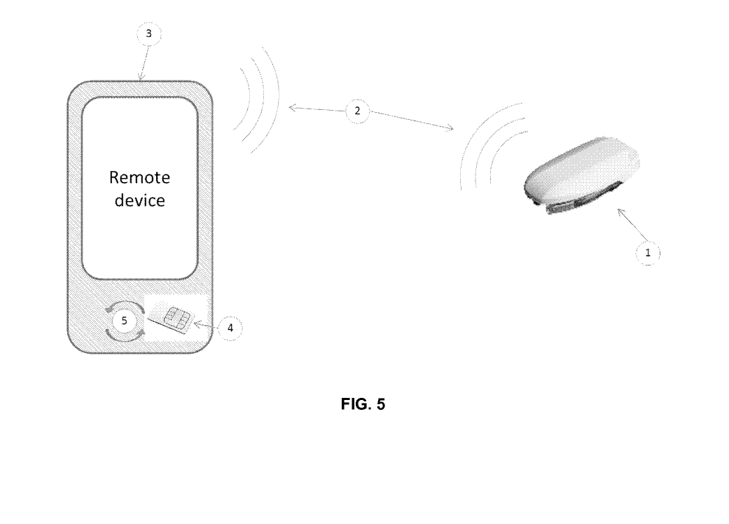

In one embodiment as shown in FIG. 5, the medical device (1) communicates with a remote control (3). Said remote control (3) is connected with a MCU (4) which may be already paired with said medical device (1). The communication (2) between said remote control (3) and said medical device (1) is established and secured thanks to the secured processing means (5) launched or executed by said MCU (4) and/or said medical device. Said memory contains all information (key information) for establishing and for securing the communication with the medical device or a medical server.

In one embodiment, the key information comprises a list of applications and/or software which can or not be run in the MCU and/or in the remote control (3) at a particular point of time. Some of said software or applications may be authorized to run in same time or be stopped when a medical application or other specific application is in use in the remote control (3) or the MCU (4). If the remote control comprises a virtual machine, the hypervisor uses said list to launch or stop (kill) the non allowed applications and/or software when the medical OS is used or when specific medical application is running. Said MCU (4) may comprise a list of scenarios to be executed when certain condition is fulfilled.

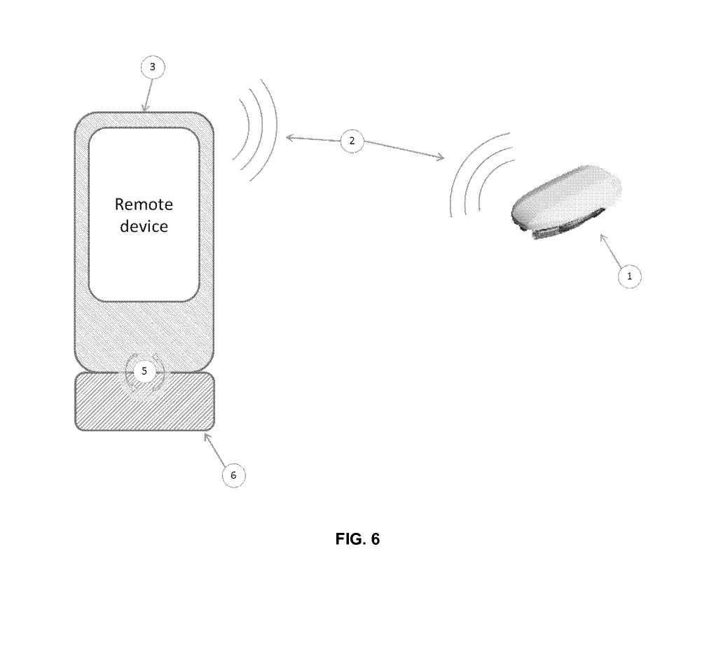

The FIG. 6 shows an external MCU (6) plugged to a remote control. Said external MCU (6) comprises a CPU, a memory (10) and connecting means (17) and may comprise a housing. Said memory contains all information for securing the communication with the medical device or a medical server. Said medical device may be already paired with said external MCU (6). The communication (2) between said remote control (3) and said medical device (1) is established and secured thanks to the secured processing means (5) launched or executed by said MCU (6). Said medical device may also use all or part of said secured processing means.

The difference between the FIGS. 5 and 6 is the MCU. The first one (in FIG. 5) is an internal MCU (4) (like a smart card) which is inserted at least temporarily into the remote control (3). The second one (in FIG. 6) is an external MCU (6) (like a dongle) which is plugged at least temporarily to the remote control (3). Thanks to its design, the external MCU (6) may comprise other features or means which are disclosed thereafter.

The secured processing means (5) may use:
a specific pairing process and/or
an encryption key to secure data and/or
an integrity test to check the integrity of the remote control and/or
a specific loopback mechanism and/or
a host and secure Operating System

The secured processing means (5) need the key information to establish and to secure the communication. It may be the link key, address (address Bluetooth, . . . ), encryption key, shared secret, hash, . . . .

In one embodiment, the MCU (4, 6, 8) keeps in its secured memory secured processing means (5) in such a way that said remote control (3) does not access to said secured processing means (5). In one embodiment, the medical device also comprises said secured processing means for processing (for example) the encrypted communication.

In one embodiment, the secured processing means (5) may use:
an asymmetric key cryptography mechanism generating at least one asymmetric key pair and/or symmetric key;
a symmetric key cryptography mechanism generating at least one symmetric key and/or asymmetric key
a cryptographic hash mechanism.

Said asymmetric key cryptography mechanism may use at least one of this algorithm: Benaloh, Blum-Goldwasser, Cayley-Purser, CEILIDH, Cramer-Shoup, Damg\dot{a}rd-Jurik, DH, DSA, EPOC, ECDH, ECDSA, EKE, ElGamal, GMR, Goldwasser-Micali, HFE, IES, Lamport, McEliece, Merkle-Hellman, MQV, Naccache-Stern, NTRUEncrypt, NTRUSign, Paillier, Rabin, RSA, Okamoto-Uchiyama, Schnorr, Schmidt-Samoa, SPEKE, SRP, STS, Three-pass protocol or XTR.

### Pairing Process

A part of the present invention discloses a specific pairing process, which may use a Bluetooth protocol (such as “classic” Bluetooth or Bluetooth Low Energy) and/or other wireless communication protocol (large or short range interface). In particular, the pairing between the remote control and the medical device is user friendly because the MCU is already paired (at least, the MCU contains pairing information of at least one medical device) with at least one medical device and does not require a specific pairing action by the user. In addition, the pairing information is not visible to the user, which means that it cannot be stolen or used by a third party, and the medical device may be no more accessible for a pairing procedure, which protects the device from unauthorized connections and excess of battery consumption caused by the pairing procedures.

The present document explains the benefice of the new pairing process and the difference with the standard Bluetooth pairing process. But, the new process and product are not limited to Bluetooth protocol.

Bluetooth pairing is generally initiated manually by a device user. The Bluetooth pairing process is typically triggered the first time when two devices are not yet paired. So, a device receives a connection request from another device. In order that Bluetooth pairing may occur, a password has to be exchanged between the two devices. This password or “Passkey” as it is more correctly termed, is a code shared by both Bluetooth devices. This “Passkey” shall be exchanged by using another communication pipe than the Bluetooth pipe (usually it is displayed and entered by the users). It is used to ensure that both users have agreed to pair with each other. But, if a hacker saw or listened the process, he could intercept the connection to the device and command it . . . . At the end of the standard pairing process, a link key is generated, share between both devices and used for establish the connections between the devices paired. The Bluetooth Low Energy uses short term key and/or long term key rather the link key, but to simplify the present document, the term link key is used also for short or long term key.

Thus, for establishing a secure connection, the devices need to share a secret in a hidden manner. This shared secret need to be known only by the medical device and its remote control. By already incorporating such shared secret in both devices, no exchange of secret information will be needed. Nevertheless, when a patient changes his remote control, the old remote control is not able to share the secret with another new device which, therefore, cannot be connected with the medical device.

Thanks to this invention, the communication between the remote control and the medical device is totally secured and the shared secret is securely kept by the medical device and its MCU, which is transferable in-between several remote controls (old and new). Furthermore, the medical device (1, 7) is never discoverable by other device, nor connectable with a device without said MCU.

For added security, the pairing between the medical device and the MCU is performed prior to use by the patient or at least prior to plug the MCU into the remote control. Advantageously, said pairing (Medical device/MCU) may be only performed with a pairing device and/or said pairing may be performed by the manufacturer, the doctor, caregiver or pharmacist. Thanks to said pairing, at least one secret is generated and stored in the medical device (1) and in the paired MCU (4, 6, 8) in a secure manner. For example, if a pairing device is required, the pairing process may be performed via a wired communication.

The medical device (1) has an address (e.g. Bluetooth address) which may be stored in the memory of the MCU (4, 6, 8) in such a manner, even if the medical device is not discoverable by standard Bluetooth protocol, the MCU can establish a communication with said medical device without exchanging sensible information which could be hacked by a third party.

So, the pairing between the MCU and the medical device allows sharing all or part of secret. During this pairing, at least a part of link key is generated and stored in the memory of the medical device and the MCU. Said link key may comprise shared secrets (e.g. encryption key, . . . ) and the Bluetooth address of the medical device. Said link key is required to establish the future wireless communications.

A remote control can read said link key stored into the MCU (4, 6, 8) in such a manner the remote control can be paired with the medical device, even if said medical device is undiscoverable. So, the remote control (3) can initiate a connection (e.g. Bluetooth connection) without using the standard pairing process. Then it transfers said parameters to the Bluetooth communication layer, which can establish straight the connection.

Since, the MCU is already paired with the medical device prior to use by the patient, the patient must just plug said MCU (4, 6, 8), which knows the link key, into her remote control and the medical assembly is ready to be used.

Advantageously, the link key is stored in the third part (13) of the memory of the MCU (8). Said third part (13) is writable and readable by the CPU but it is unwritable and readable by other device. Thus, the link key may be read by the remote control but said remote control cannot change the link key. In other term, the MCU cannot be paired once more.

As disclosed above, a pairing device (16) may be used to perform the pairing process.

Said pairing device (16) comprises two connecting means, one for connecting the medical device and the other for connecting the MCU. When the user plugs the medical device and the MCU to the pairing device (16), the paring process can be performed. Thanks to this pairing device, the medical device and the MCU can share their secret (e.g. the link key, . . . ) in a really secure manner. The pairing device may comprise wired communication means for performing a secure data exchange between MCU and medical device. The pairing device can also be used for several remote controls, since it can be unplugged and plugged several times.

In one embodiment, said MCU and/or medical device cannot accept a new pairing request.

Thanks to this specific pairing process, the medical device is easily and securely connected to the remote control. Once, the MCU and the medical device are paired, the remote control has to read the parameters (e.g. link key) stored in the MCU and use it.

The pairing between a MCU (4, 6, 8) and a medical device (1, 7) comprises the following steps:
Providing a MCU (4, 6, 8) and a medical device (1, 7)
Providing a means for allowing a communication between said MCU (4, 6, 8) and said medical device (1, 7)
Sharing at least one secret between the MCU (4, 6, 8) and the medical device (1, 7).

Said at least one secret may comprise the medical device address, the link key and/or other keys.

Said means for sharing all or part of said key information (e.g. pairing device) may comprise input means, wired connection, display means and/or means for performing the pairing process (such as an application, . . . ).

The pairing between a remote control (3) and a medical device comprises the following steps:
Providing a medical device (1, 7), a remote control (3) and a MCU (4, 6, 8) which is already paired with said medical device (1, 7)
Plugging said MCU (4, 6, 8) into said remote control (3),
Using the pairing data contained in the memory of said MCU (4, 6, 8) and in the memory of said medical device to connect the medical device with the remote control (3),

Advantageously, said MCU (4, 6, 8) and said medical device (1, 7) may use a cryptographic mechanism to authenticate the connection, as well as means for generating a session key or other key.

In one embodiment, the medical device may comprise connecting means for connecting temporarily said MCU to perform the pairing process.

Secure the Communication between the Remote Control and the Medical Device

The present document discloses above a secure pairing process, which permits to perform the pairing process in a secure manner. This process can be used alone, but to add more security, the data must be exchanged in a secure manner.

To secure the communication between the remote control and the medical device, the medical device may use at least one encryption key data and/or loopback mechanism.

### Encryption Key:

As disclosed above, the memory of the MCU (4, 6, 8) may contain key information (such as but not limited to: communication configuration, public key, private key, cryptography process, link key, . . . ) to allow a secure communication with the medical device which also knows, partially or integrally, said key information. Without said key information, it is not possible to connect to the medical device (1, 7) and/or encrypt/decrypt the data.

In one embodiment, said key information contains at least one encryption key, in such a way that the remote control (3) and the medical device (1, 7) can exchange encrypted data and/or authenticate the sender. Said at least one encryption key may be an asymmetric key and/or symmetric key. As such, given data is encrypted by the MCU or by the remote control, but the medical device (1, 7) can decrypted said data. Vice versa, the medical device (1, 7) can send to the remote control (3) encrypted data and said encrypted data may be decrypted by the MCU or by the remote control.

A key generator generates at least one encryption key which is recorded in the memory of the MCU and/or in the memory of the medical device. For added security, said at least one encryption key must be kept secretly and only shared between the MCU and the medical device.

In one embodiment, at least one encrypting key is an asymmetric key. A key generator generates a private key, which is stored in the memory of the MCU and a public key, which will be stored in the memory of the medical device. Said private key can be used by the remote control or by the MCU while said public key is only used by the medical device. Thus, a memory of said MCU contains a private key and a memory of said medical device contains the appropriate public key. Advantageously, said public key is secretly kept by the medical device and is never shared with other devices or via bluetooth.

In one embodiment, the MCU keeps secret and does not share said private key with a remote control in such a manner that when the MCU is removed from the remote control (after use of said remote control with the MCU), the remote control cannot use said private key and so the remote control cannot communicate with the medical device. Advantageously, said private key is stored in the second or the fourth part (12, 14) of the memory of the MCU, so the private key cannot be readable by another device. In particular case, if the private key is only stored in the fourth part (14), the private key cannot be rewritable by another device. The public key, which is used by the medical device, must preferably be kept secret by the medical device. Nevertheless, if a hacker finds said public key, this hacker only decrypts the data sent by the remote control (e.g. the treatment, order, . . . ). It is less dangerous than if the hackers finds the private key (stored in the MCU's memory) because in this particular case, the hacker could simulate the remote control and change the patient treatment regimen (e.g. insulin delivery, . . . ).

In one embodiment, a key generator generates at least two asymmetric keys (A and B). A private key A is stored in the MCU and the appropriate public key A is stored in the medical device. The private key A can be used by the remote control and/or the MCU and the public key A is used only by the medical device. A private key B is stored in the medical device and the appropriate public key B is stored in the MCU. The public key B can be used by the remote control and/or the MCU and the private key B is used only by the medical device. So in this embodiment, the medical device comprises the public key A and the private key B, and the MCU comprises the public key B and the private key A. Said public key B and said private key A may be stored in the unreadable part (in the writable or unwritable part) of the MCU's memory. Thus, the communication is totally secured and the sender is authenticated. Indeed, when the medical device receives a message, which is decryptable with the public key A, the medical device knows the expeditor (the remote control) and vice versa, when the remote control receives a message which is decryptable with the public key B, the remote control knows the expeditor (the medical device). The use of two asymmetric key allows to authenticate the sender.

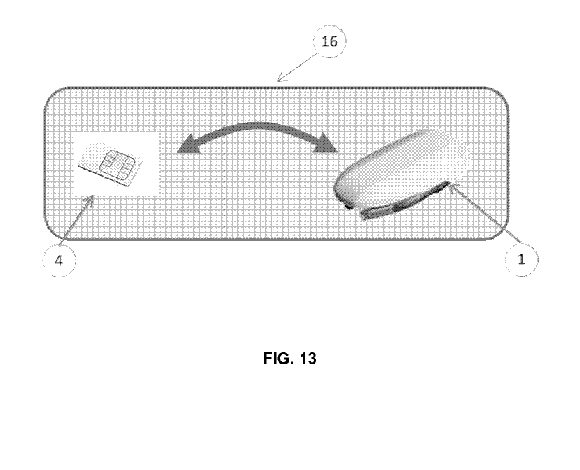

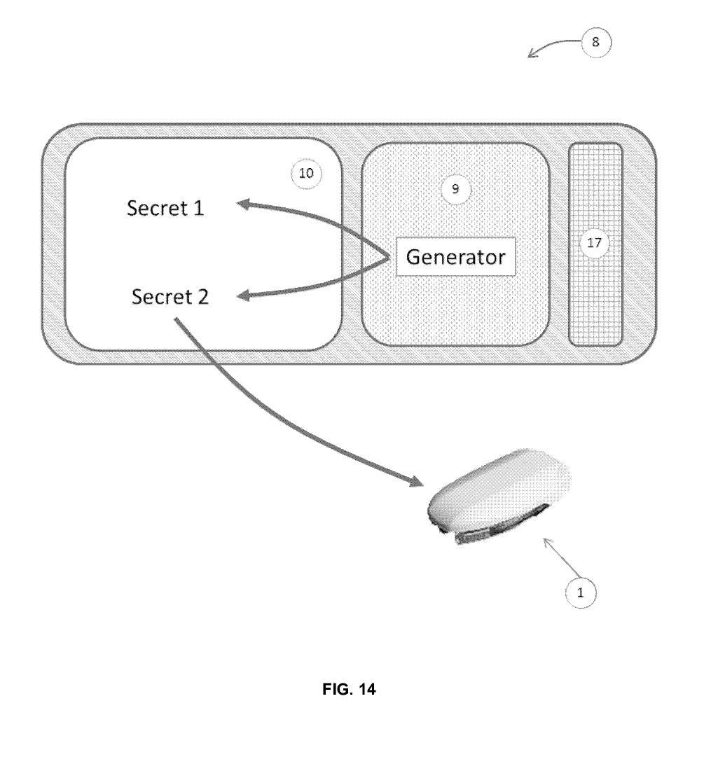

In one embodiment, the CPU of the MCU (8) comprises a key generator which generates at least one encrypting key which will be shared. Said CPU (9) may also comprise other function, such as an encryption engine . . . . For example as disclosed in the FIG. 14, the MCU (8) comprises a CPU (9) in which a generator is executed to generate at least one secret. The secret may be all or part of the key information (link key, encryption key, hash, . . . ). In the FIG. 14, two secrets are generated and both are stored in the memory (10) of the MCU (8). Secret 1 and secret 2 may be equal, associate or distinct. The secret 1 is kept in the MCU's memory (10) and the secret 2 is shared with the medical device (1). In this case, the secret 1 may be stored in the second and fourth (preferred) part of the MCU's memory and the secret 2 may be stored in the first or third part of the MCU's memory. So the secret 2 can be read in order to be sent to the medical device. Then, the secret 2 may be deleted of the MCU's memory (10). For instance, the public key A may be stored in the first part of MCU's memory, because said secret has to be sent to the medical device, after which it will be preferable to delete said secret on a given device (e.g. pairing device as described thereafter). The link key may be stored in the third part of the MCU's memory, because said secret should not be deleted. This process may be performed with the remote control or with a specific device, as the pairing device (16) shown in FIG. 13.

In other embodiment, the generator is executed within the medical device. In another embodiment, the medical device and the MCU execute their own generator to generate at least partial key information, which may be at least partially shared between the MCU and the medical device.

In one embodiment, the generator as described above is executed or launched by a specific device, like a pairing device (16).

The generator may be launched by the manufacturer, doctor, caregiver or pharmacist.

During or after the generation secret process, other information may be recorded in the memory of the MCU and/or the medical device, such as characteristics of the patient, drug, treatment, regimen, treatment security limits, . . . .

In one embodiment, to secure at least one communication with the medical assembly as described in the present document, a method comprises the following steps:
Generating an asymmetric key comprising a private key and an appropriated public key
Storing said private key in a secure memory of the MCU
Storing said appropriated public key in a memory of the medical device
Encrypting data A with said private key or encrypting data B with said public key
Transmitting said encrypted data A to the medical device or transmitting said encrypted data B to the remote control
Decrypting data A using said public key or decrypting data B using said private key

Said key exchange may be performed by wired communication and launched by the pairing device prior to be used by the patient. The key generation may be performed by a key generator launched by, or executed in the MCU.

An asymmetric key uses several resources and it will be preferable to use a symmetric key. So, the asymmetric key may be used at the start of session communication and after use a symmetric key (as a session key). Said symmetric key may be temporarily used and periodically changed.

In one embodiment, to secure at least one communication with the medical assembly as described in the present document, a method comprises the following steps:
Establishing a first communication between the remote control and the medical device
Generating a negotiation value Vm by the medical device
Transmitting said negotiation value Vm to the remote control
Transmitting said negotiation value Vm to the MCU
Computing session key Ks and a negotiation value Vrc by the MCU
Encrypting at least session key and/or said negotiation value Vrc by the MCU using said private key
Transmitting said encrypted data to the remote control
Transmitting said encrypted data Vrc to the medical device
Decrypting said encrypted data by the medical device using said public key

The medical device can compute also a session key. Said session key may be kept secret or used to check with the session key generated by the MCU. The medical device may check the authentication using said encrypted data and/or said public key.

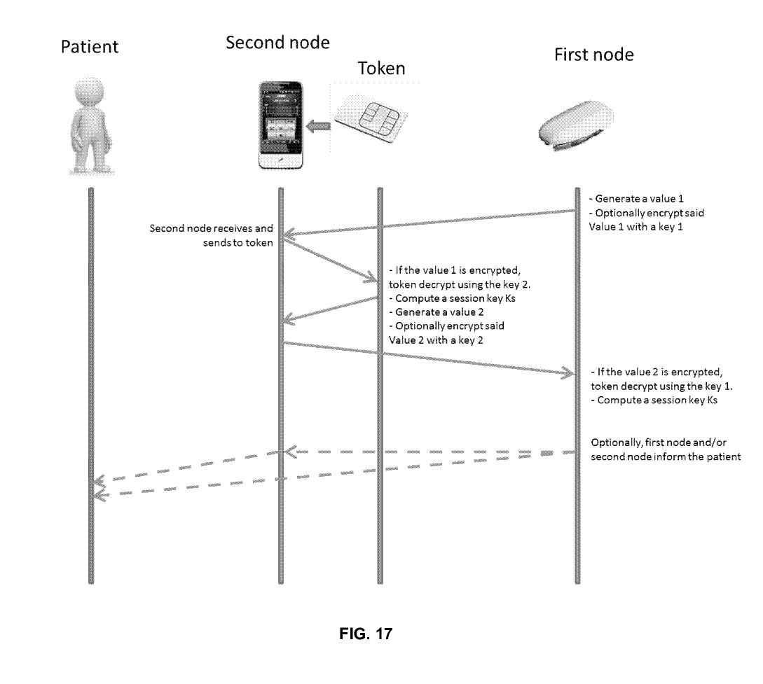

In one embodiment shown in FIG. 17, to secure at least one communication between two distinct nodes, one of them comprising a token, a method comprises the following steps:
Providing two distinct nodes: 1 and 2. Said node 1 may comprise an encrypted key 1, a key generator and an encryption engine. Said node 2 comprises means for connecting to said token which may comprise an encrypted key 2, a key generator and an encryption engine.
Initialising a first communication by a first node
Generating a value V1 by the first node
Encrypting said value V1 with the key 1 (optional)
Transmitting said (encrypted) value V1 to the second node
Transmitting said (encrypted) value V1 to the token
Decrypting said value V1 with the key 2 (optional)
Generating a value V2 by the token
Generating a session key 1 by the token using the value V1 and V2
Encrypting said value V2 with the key 2 (optional)
Transmitting said (encrypted) value V2 to the second node
Transmitting said (encrypted) value V2 to the first node
Decrypting said value V2 with the key 1 (optional)
Generating a session key 2 by the first node using the value V1 and V2

The session key 1 and 2 must be equal to authenticate and exchange encrypted data in secure manner. The first node may be the medical device or medical server and the second node may be the remote control. The token may be in the MCU. The encrypted keys may be asymmetric or symmetric key. The encrypted key 1 may be a public key and the encrypted key 2 may be a private key. Optionally, the first node and/or the second may inform the patient that the communication is now performed in a secure manner by visual, sound indication and/or vibrator.

In the case where the first node tries to connect with a false token, thanks to the encryption key, said token cannot decrypt correctly the value V1. Consequently, this token generates a session key 1 which differs from the session key 2 and this token cannot exchange data with said first node.

So thanks to this process, said MCU and said medical device never exchange any key in wireless communication. In one embodiment, said session key is kept secretly in the token, which comprises an encryption engine to decrypt and encrypt using said session key. In another embodiment, said token shares with the second node the session key (the token may keep secretly or share also the key 2) and said second node comprises an encryption engine to decrypt and encrypt with said session key.

### Loopback Mechanism

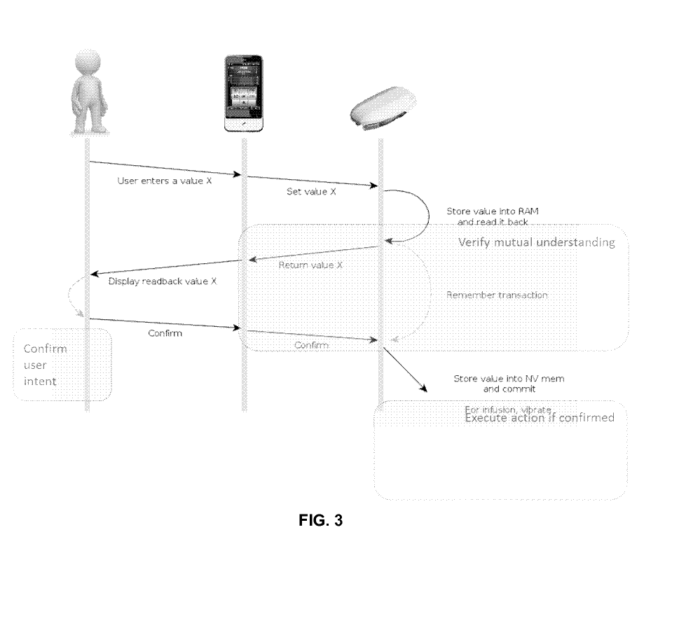

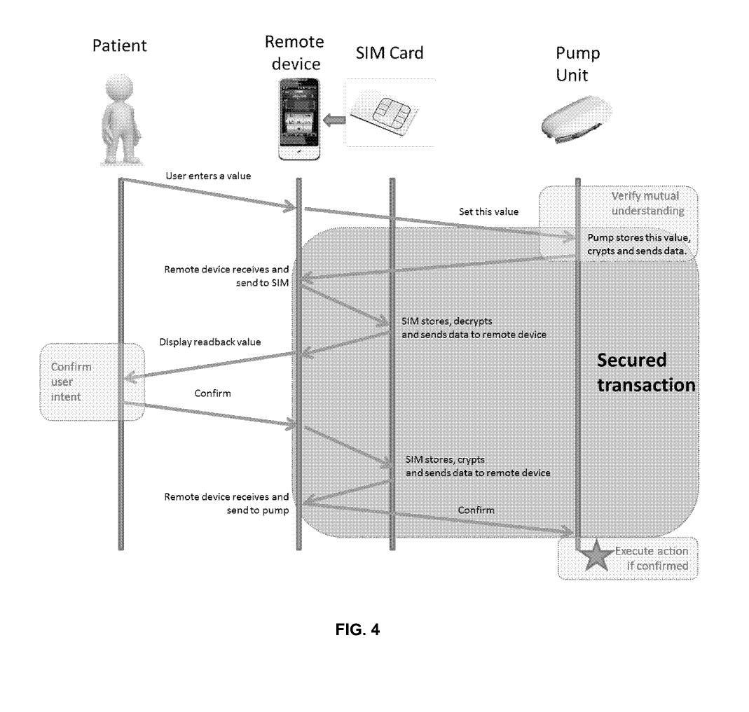

The next paragraphs relate to an embodiment of the invention, which comprises a loopback mechanism. This feature may provide a secure communication between the medical device and the remote control, by taking into account that the architecture disclosed previously or a similar level of security is provided inside the remote control in order to ensure a secured bridge between the assembly according to the invention and the information read or entered by the patient. FIGS. 3 and 4 illustrate the use of a loopback mechanism with the remote control (3) according to the invention.

The loopback is a mechanism that ensures that a command executed on the medical device (1, 7), along with its parameters, has been requested by the operator (authentication) and corresponds to his wishes (integrity). More precisely, the mechanism first ensures that the information transmitted between the remote control (3) and the medical device (1, 7) is not altered, either by accident (memory failure, communication interferences), or voluntarily (attacker, malware). Furthermore, the mechanism ensures that the command has indeed been requested by the user. These two functions are accomplished by the following tasks such as but not limited to:
The commands, along with its parameters, are transmitted by the remote control (3) to the medical device (1, 7).
The medical device (1, 7) generates a challenge based on the command and its parameters, and returns it to the remote control (3).
The remote control (3) extracts information from the challenge and displays it to the user for confirmation. In one embodiment using an external MCU, which comprises a display means, said information may be displayed on the display means of the external MCU. This information includes the command and its parameters as received by the medical device (1, 7).
The user signals his approval and confirmation by entering a PIN known only by him. The remote control (3) generates the response to the challenge using the PIN and the challenge itself.
The response is transmitted to the medical device (1, 7) and verified by it. The command actually starts executing only if the challenge's response is correct.

This mechanism differs from a standard “login” mechanism, in the sense that the PIN used by the user validates only for the particular instance of challenge-response. In such a way, each command has to be validated by the user, thus a malicious application can't send a new command right after the user has entered the PIN Code. Furthermore, another person cannot send a command with the correct remote control or other device by mistake or intentionally because the user is the only person to know the PIN code (optional).

It differs also from just repeating the requested command to the user with a “Are you sure?” mechanism, in the sense that the information showed to the user and for which his approval is requested is information returned by the target device. If any alteration has taken place, this returned value will automatically differ from the information originally entered by the user.

Said confirmation isn't automatically handled by the remote device so that a malicious application can't control said confirmation. It is essential that the confirmation is permitted only by the user. In one embodiment, the loopback mechanism use a PIN code to confirm the command sent and only the user knows said PIN code.

Preferably a direct secured pipe is created between the memory of the medical device and a secured buffer on the remote control, which contains the displayed values. Then an authorized application on the remote control (3) displays the value and records a user authentication, which will be used to construct the return value, which is sent back to the medical device. This secured pipe can be initiated by using key information that is inside the additional MCU.

The secured pipe is open when the user has finished defining the parameters that he wants to program on the medical device. It is closed when the user has acknowledged the parameters in order to allow the medical device using them.

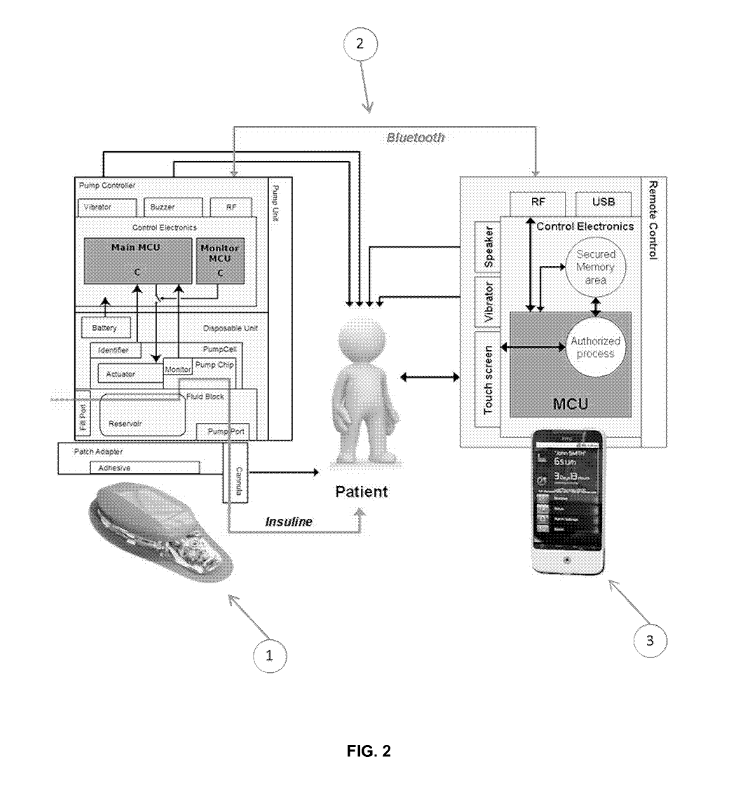

The loopback process according to the present invention comprises the implementation of the following elements:
A secured memory area in the medical device
A secured process in the medical device that manages the encrypted communication of data between the secured memory area of the medical device to the remote control.
A secured display memory area in the remote control
A secured process on the remote control that manages the encrypted communication of data between the medical device to the secured display memory area of the remote control.
A secured and authorized process on the remote control that transfers the data from the secured display memory area to the display of the remote control and builds the acknowledgement ticket of the user.
   The architecture of these different elements is illustrated in FIG. 2.

The loopback process is initiated when the medical device has received a set of parameters, which will change the set-up of the therapy or any security feature like the alarm settings.

In one embodiment shown in FIG. 3 which doesn't use an additional MCU, an medical assembly (at least one medical device and one remote control) comprises:
a memory in said medical device which may contain a secured memory area,
secured processing means (5) in said medical device that manages the encrypted communication of data between said secured memory area and the remote device,
a secured memory area in the remote control,
secured processing means (5) in the remote control that manages the encrypted communication of data between the medical device and said memory area,
secured and authorized processing means (5) on the remote control that transfers the data from the secured memory area to the display of the remote control and builds the acknowledgement ticket of the user.

If the embodiment does not use an additional MCU, the loopback process between two distinct nodes and a user may comprise the following steps:
Receipting by a first node a command sent by a second node
Storing said command in the memory of the first node
Encrypting said command by the first node using an encryption key A
Sending said encrypted command to the second node
Receipting by the second node said encrypted command
Decrypting said encrypted command by the second node using an encryption key B
Displaying said command on the display means of the second node
Checking the command by the user
Validating by the user of said command using inputs means of the second node
Sending said validation to the first node.

Said encryption key A and B may be equal or associate. To add more security, the process may further comprise challenge generating, PIN Code, status indication, . . . .

So, in detail the process (illustrated in FIG. 3) may comprise the following steps:
Done by the embedded software in the medical device
   Write the parameters that must be acknowledged in the memory of the medical device
   Optionally, generate a random information, commonly named a challenge
   Open a secure pipe between the medical device and the remote control
   Optionally, indicate to the user that the medical device and remote control is in loopback mode by means such as a vibration, sound, LED or any other method that informs the patient.
   Send the parameters encrypted by using an encryption key called KP and the challenge to the remote control.
Done by the software entity 1 in the remote control
   Receive and write the encrypted parameters and the challenge to the secured memory area of the remote control.
Done by the software entity 2 in the remote control
   Decrypt the parameters by using the key called KRC, which is the corresponding key to KP. These keys can be symmetric or asymmetric. The authorized application is validated by having the correct corresponding key KRC.
   Display the decrypted parameters in a “Summary” page.
   Optionally, enter the PIN code of the user.
   Build the acknowledgement ticket that will confirm the acceptance of these parameters by using the challenge, the key KRC and the entered PIN code.
   Write the ticket in secured memory area of the remote control.
Done by the software entity 1 in the remote control
   Send this ticket back to the medical device.
Done by the embedded software in the medical device
   Optionally, calculate the expected ticket
   Receive and validate the acknowledgement ticket coming from the remote control.

When the ticket is validated the loopback process is closed and the medical device is allowed to use the updated parameters. This basic process can be more elaborated or part of a more complex scheme in order to improve the security of the secured pipe.

In one embodiment, said software entity 1 and said software entity 2 are the same software entity or software entity 1 may be embedded software in the remote control (3) and software entity 2 may be an authorized application in the remote control (3). In another embodiment, said software entity 1 is running by the host Operating System as defined thereafter and the software entity 2 is running by the medical Operating System as described thereafter.

One of skill in the art will appreciate that there are several ways to encrypt the data send and to generate said ticket. The invention is not limited to a particular way to encrypt the data send or to generate said ticket.

If the embodiment uses an additional MCU, the loopback process between two distinct nodes and a user may comprise the following steps:
Receipting by a first node a command sent by a second node
Storing said command in the memory of the first node
Encrypting said command by the first node using an encryption key A
Sending said encrypted command to the second node
Receipting by the second node said encrypted command
Sending said encrypted command to the MCU
Receipting by the MCU said encrypted command
Decrypting said encrypted command by the MCU using an encryption key B
Displaying said command on the display means of the second node
Checking the command by the user
Validating by the user of said command using inputs means of the second node or of the MCU (if it is an external CMU comprising inputs means such as a validation button)
Sending said validation to the first node.

Said encryption key A and B may be equal (symmetric), associate (asymmetric). To add more security, the process may further comprise challenge generating, PIN Code, status indication, . . . .

So, in detail the process (illustrated in FIG. 4) may comprise all or part of the following steps:
Done by the embedded software in the medical device:
   Write the parameters that must be acknowledge in the memory in the medical device
   Optionally, generate a challenge
   Encrypt said parameters by using a temporary key Ks1
   Optionally, indicate to the user that the medical device and remote control is in loopback mode by means such as a vibration, sound, LED or any other method that informs the patient. In one embodiment, the MCU is an external MCU which comprises a means for transmitting said information to the user (LED on the MCU, display means, vibrator, . . . )
   Send the encrypted parameters and/or the challenge to the remote control
Done by the embedded software in the remote control
   Send the encrypted parameters to the MCU.
Done by the embedded software in the MCU
   Receive and write the encrypted parameters and the challenge in the memory of the MCU.
   Decrypt the parameters by using the key Ks1.
   Send the decrypted parameters and the challenge to the memory of the remote control
Done by the embedded software in the remote control
   Display the decrypted parameters in a “Summary” page.
   Optionally, prompt the user to enter the PIN code.
   Build the acknowledgement ticket that will confirm the acceptance of these parameters by using the challenge (optional), the parameters and the entered PIN code (optional).
   Write the ticket in the memory of the remote control.
   Send said ticket to the MCU
Done by the embedded software in the MCU
   Receive and write said ticket to the secured memory area of the MCU
   Encrypt said ticket by using a temporary key Ks2
   Send said encrypted ticket back to remote control
Done by the embedded software in the remote control
   Send the encrypted ticket back to the medical device.
Done by the embedded software in the medical device
   Optionally, calculate the expected ticket
   Receive, decrypt and validate the acknowledgement ticket coming from the remote control.

When the ticket is validated the loopback process is closed and the medical device is allowed to use the updated parameters. This basic process can be more elaborated or part of a more complex scheme in order to improve the security of the secured pipe.

In one embodiment, the PIN may be entered while using a random array display on the remote control device in order to prevent any application that would mimic user actions or intercept this information. For example, the numbers (5 from 0 to 9) would be displayed in a random order which would be different every time a PIN code shall be entered by the user. In other embodiment said PIN may be replaced by symbols, pictures, words, forms which must be redrawn, entered or copied to validate the command, all of which intention is to make sure there is an intelligent human being interacting with the display.

In another embodiment, the PIN can be changed by another authentication means such as but not limited to fingerprint readers, fingerprint retinal, . . . . The authentication means must be known or owned only to the user.

In one embodiment, said embedded software in the remote control is running by the host Operating System as defined thereafter and said embedded software in the MCU is running or launching by the medical Operating System as described thereafter.

If the MCU is a dongle as shown in FIG. 4 or 5 and if said dongle comprises means for transmitting information to the patient, the challenge may be displays on its display means. Said means may inform the patient that the secure mode or OS or loopback mode is in progress.

In one embodiment, the challenge may be encrypted too.

In one embodiment, the key Ks1 and Ks2 may be asymmetric key pair or symmetric key or use a hashing mechanism.

In one embodiment, the key Ks1 and Ks2 are same or different.

In one embodiment, the user has to enter a PIN code to confirm the entrance in loopback mechanism, such PIN code being entered on a random displayed array.

In one embodiment, the MCU is an external MCU which comprises an input means in such a manner that the PIN code may be entered with said input means or said input means is a print finger reader. In another embodiment said print finger reader is in the remote control.

Secure the Communication Between the Remote Control and the Medical Server

In one embodiment, said MCU (4, 6, 8) contains the key information to establish and/or secure communication between said medical assembly and a medical server (e.g. telemedicine). In such a way, all or part of the data may be securely send to the medical server where said data may be analysed or stored.

All or part of the features described in the present document may be used to establish and/or secure a communication between a remote control and a medical server or a medical server and a medical device where the remote control may be used as a gateway.

### Other Features of the MCU

In one embodiment as shown in FIGS. 6, 7, 8 and 12, the external MCU (6) may be considered as or be an external device (as a dongle).

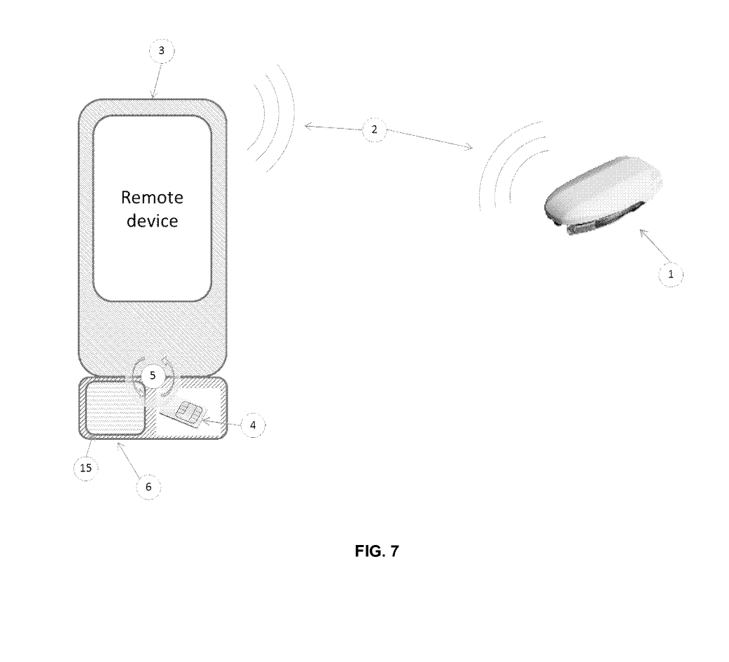

In one embodiment, the external MCU (6) may be used as a simple dongle and said external MCU (6) may comprise an additional connecting means (15) for connecting to an internal MCU (4), as shown in FIG. 7. In this particular case, the dongle (6) may be used as an intermediate or adaptor between the remote control (3) and the internal MCU (4). Thus, all or part of the key information or program is not necessarily stored in the memory of said dongle (6). An internal MCU (4) must be used to store all or part of the other key information. For example, the dongle (6) may comprise the key information to check the integrity of the OS, mOS or application executed by the remote device or the software which will be installed in the remote control (3). The internal MCU (4) may comprise the key information such as the link key, encryption key, . . .

Furthermore, if the patient changes her remote control (because broken or battery failed) and if the new remote control does not comprise suitable connecting means for an internal MCU (4), it will be useful to have this dongle (6). So, thanks to this external MCU (6), the remote control (3) is connected to the internal MCU (4). The additional connecting means may perform wire or wireless communication between the external MCU (6) and the remote control (3).

Said MCU (6) may comprise all precedent elements and other means or features (15) as described thereafter.

An external MCU (6) may comprise a sensor, such as but not limited to:
a blood glucose measuring means in such a way, said MCU (6) may be also used like blood glucose monitoring,
An accelerometer for monitoring the activity of the patient, . . . .

A MCU (6) may comprise a display means for displaying securely the data in such a way that the patient has two distinct display means, the first one located on the remote control and a second one located on the dongle or external MCU (6). Thus, the first one is used to program or monitor the medical device and the second one may be used to confirm the data or to receive and display all or part of the challenge of the loopback or other information. As such, the security level required on the remote control can be minimized, since the patient will have to review all safety relevant program changes required on the display of the MCU (6), which information are fully secured, before confirming such program changes to be implemented in the medical device.

Such an external MCU (6) may comprise input means for setting data in a secure manner, or for entering the PIN code or print finger reader. Said inputs means may also be a validation button, to validate the data prior to send or used in loopback mechanism.

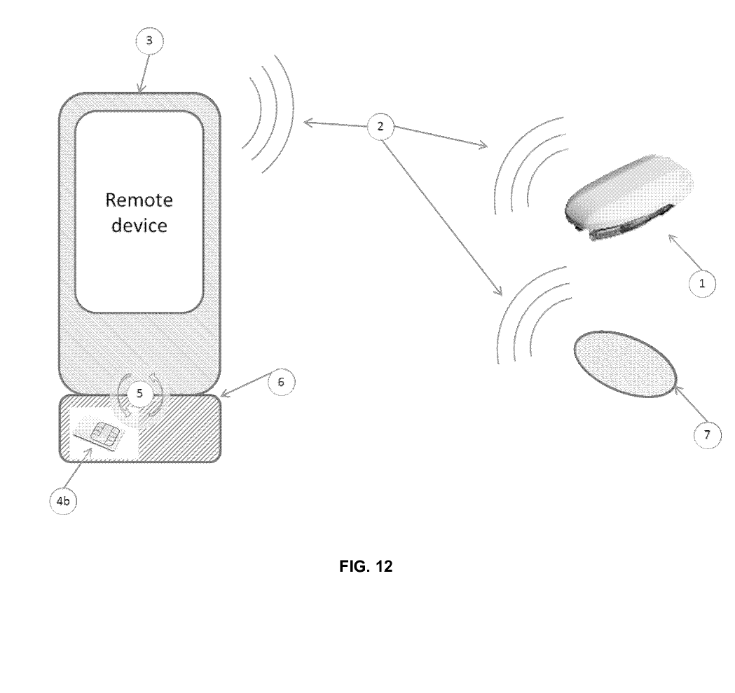

As shown in FIG. 12, the external MCU (6) may comprise at least one more connecting means for connecting to another MCU (4). Thus, the external MCU (6) may be already paired with a medical device (for example a delivery device) and the internal MCU (4b), plugged into the external MCU (6), may be paired with another medical device (for example a blood glucose meter). Said external MCU stores the key information of the first medical device and said internal MCU stores the key information of the second medical device.

If the external MCU comprises expensive other means (15) (like sensors, communication means, display means, . . . ), it will be preferable to use a simple dongle (6) (as shown in FIG. 7) with an additional internal MCU (4). Since the medical device is paired with only one MCU, when the patient changes his medical device, he can keep his dongle (6) while he changes the couple internal MCU (4)—Medical device (1).

In one embodiment, said MCU (6) may comprise communication means to communicate securely with the medical device without depending of the remote control. In this embodiment, the remote control, which may be a mobile phone, is used advantageously for its display means and/or to power said MCU.

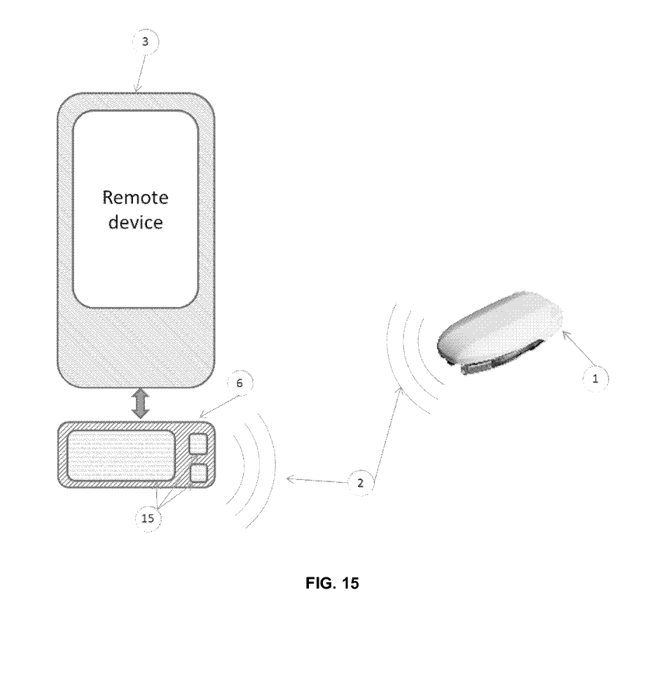

In one embodiment shown in FIG. 15, an external MCU (6) can be unplugged from the remote control (3) and be used as a light remote control. For example, if said external

MCU (6) comprises inputs means (15) and communication means (15) (optionally: power supply, display means . . . ), without the remote control, said external MCU could control, at least partially, the medical device. Said inputs means can be used to command bolus and/or suspended mode and/or other delivery command or mode.

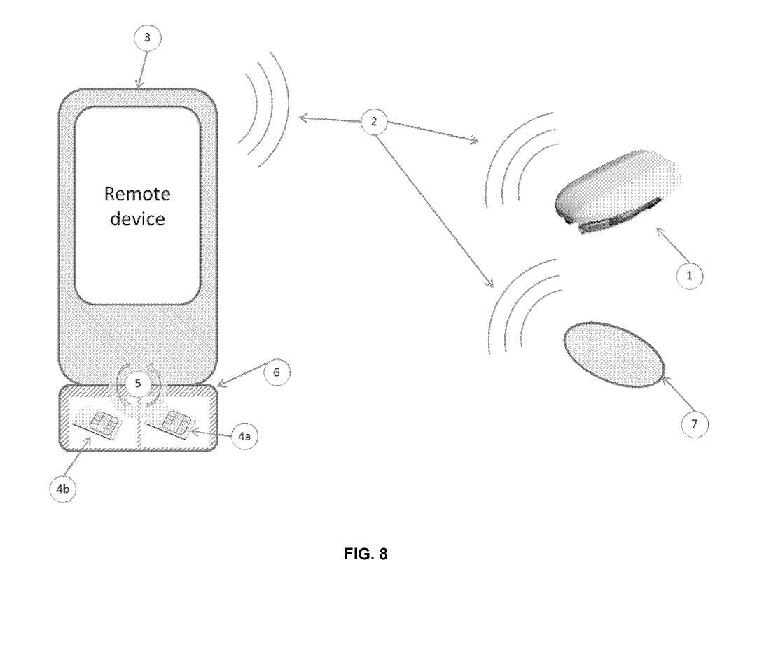

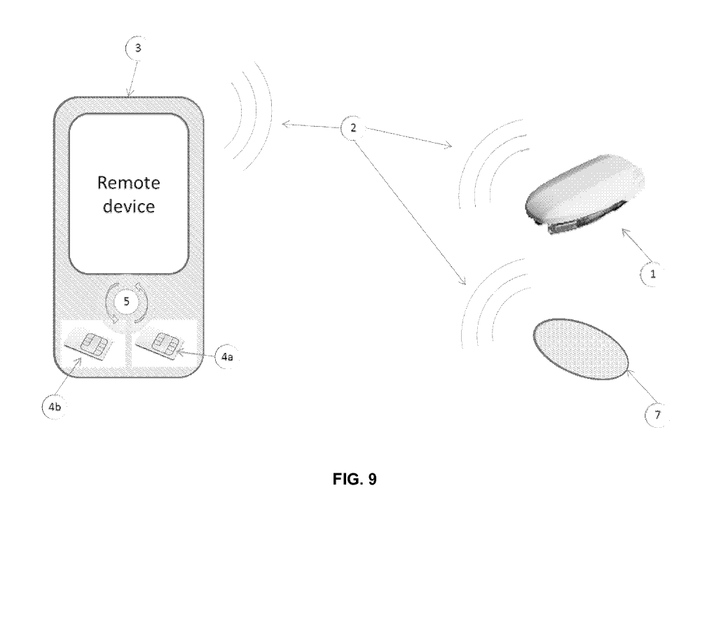

In one embodiment as is shown in FIGS. 8 and 9, two medical devices (1, 7) communicate with a remote control (3). For example, the first medical device (1) is an insulin pump (1) and the second medical device (7) is a continuous blood glucose meter (7). Each medical device is only paired with its own MCU (4a, 4b). The embodiment as is shown in FIG. 8 discloses a remote control (3) plugged to an external MCU (6). Said external MCU (6) comprises two distinct connection means to insert two distinct internal MCU (4a, 4b). The embodiment as is shown in FIG. 9 discloses a remote control (3) comprising inside two distinct connections means to insert two distinct MCU (4a, 4b). The second MCU (4a) (respectively, the third MCU (4b)) comprises a secured memory containing the key information with the first medical device (1) (respectively, the second medical device (7)). Said second MCU (4a) is only paired with the first medical device (1) and said third MCU (4b) is only paired with the second medical device (7). The embodiment may comprise more MCU and medical device.

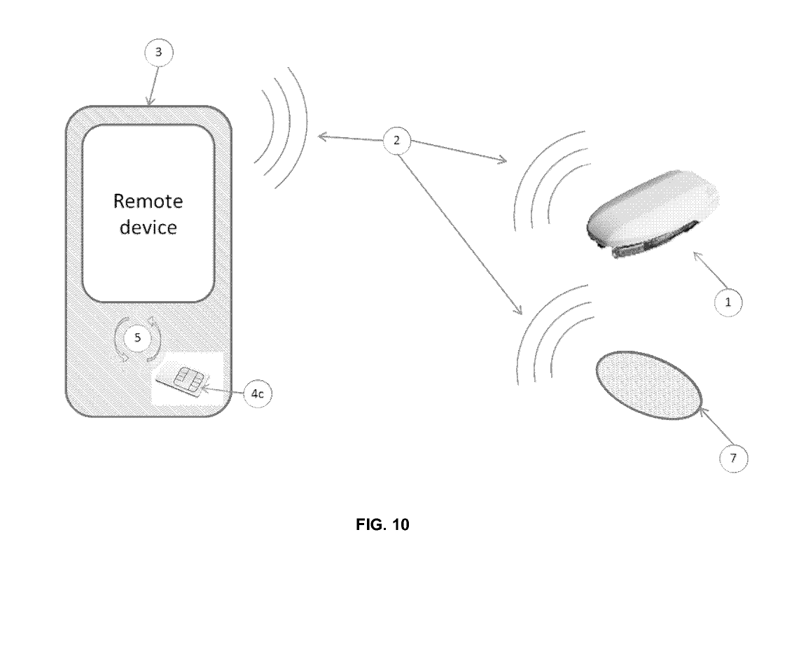

In one embodiment as is shown in FIG. 10, two medical devices (1, 7) communicate with a remote control (3) but only one MCU (4c) is plugged. For this embodiment, said MCU (4c) is paired with said two medical devices (1, 7) and comprises at least one secured memory containing the key information with said two medical devices (1, 7).

In one embodiment, an external MCU (6) comprises display means and/or input means. Some data (e.g. the critical data) is displayed on the display means of the external MCU and/or the input means allows validating said data prior to use by the medical device. For example, the remote control allows programming a command for the medical device and the external MCU allows validating said command. A loopback mechanism may be performed at least partially by said external MCU. Said display means may display the challenge or the command prior to execute by the medical device.

Although, the embodiments described above use one or two medical device, the invention isn't limited to that embodiment, the invention can have one or more medical device and one or more MCU.

### Remote Control

In one embodiment, the remote control (3) is a cell phone and the MCU (4) is a sim card, which includes all data and applications of the telephone operator. Furthermore, said Sim card comprises all data and applications to pair and to communicate securely with the medical device.

In another embodiment, said cell phone comprises two distinct connecting means, the first one to plug the SIM Card of the telecom operator and the other to plug the MCU paired with the medical device.

In one embodiment, said remote control is also used as a cell phone and a BGM or a link to a CGM. Said medical assembly comprises two distinct smart cards. The first is the Sim card used by the phone operator and the second smart card is used for controlling the medical device. Both smart cards must be plugged into the remote control to use all functionality (phone, remote control, BGM, CGM . . . ). But if one of said first smart card is missing, the remote control cannot be used as cell phone, but it can control the medical device and be used as BGM. If the said second smart card is missing, the remote control cannot be used to control the medical device, but it can be used as BGM, CGM and/or cell phone. If both are missing, the remote control is only used as BGM or CGM.

In one embodiment, said remote control comprises a second display means to display only the secure information (for example: challenge, PIN, . . . ).

For added security, said remote control (3) may comprise a virtualization platform and/or an integrity test.

### Integrity Test

In one embodiment, said medical device (1, 7) and/or said MCU (4, 6, 8) comprise secured processing means (5), such as secure boot process and/or secure flash process and/or a cryptographic mechanism, which check at least the integrity of the remote control and/or manage a secured communication (2) of data between said medical device (1, 7) and said remote control (3).

Thus, said MCU (4, 6, 8) may be used to ensure the integrity of the remote control (3), such as but not limited to its operating system and/or hOs and/or applications, . . . . Typical way to ensure this integrity is to use a secure boot or a secure flash, which is a function that performs an integrity check during the boot of the remote control (3) or at regular interval via a monitoring system.

For example, an embodiment using the secure boot process: in order to ensure that the software running on the remote control (3) has not been modified, either by accident (hardware failure) or intentionally (attacker, malware), a mechanism of secure boot is used. When the remote control (3) is turned on, the first code executed by its processor is a routine that will compute a signature of the contents of the remote control (3) internal storage (Flash memory), and verify the validity of this signature. Once the signature has been verified as valid, that processor continues with its normal OS startup procedure. Otherwise, the system does not start up. It's important to note the verification of the signature may be performed using the MCU (4, 4a, 4b, 4c, 6, 8), which ensures that no secrets (keys) are exposed.

Another example, an embodiment using the secure flash process: we wish to allow the user to take advantage of newer versions of the remote control OS (which may be download from a medical server). Similarly, in order to prevent the software of the remote control (3) to be updated with unauthorized software, the new software to be written must be signed. When the remote control (3) is started in update mode (with a long press on the power button, for example), the processor executes first a routine that will download the image of the new software, compute its signature and verify it, before overwriting the existing software. Again, it's important to note the verification of the signature may be performed using the MCU (4, 6, 8), which ensures that no secrets (keys) are exposed.

Thus, the integrity of the remote control can be check by the MCU which stores secretly in its memory the key information like the signature (as hash) of the OS and/or application.

In one embodiment, if the integrity test is a successfull, the communication is established. If it is not successfull, the MCU launches a process to inform the patient and/or the pump that the OS or application is corrupted. Said MCU or said medical device may display an error on a display device, or inform by other means (sound, vibrator, . . . ).

Using a host Operating System (hOS)

In one embodiment, the remote control (3) use of a mobile virtualization platform offers the possibility to divide the remote control (3) (e.g. a smartphone) into a controlled environment (e.g. for controlling the medical device ) and an uncontrolled environment (e.g. for general purpose tasks). The virtualization platform can be defined via a virtual machine application.

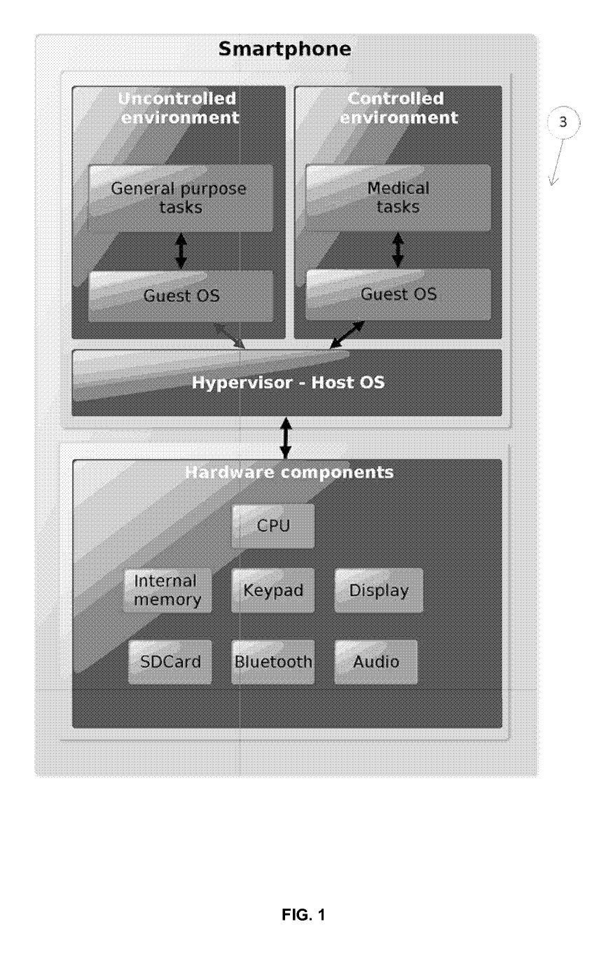

The architecture below describes a non-limitating example of a virtualization platform according to the invention (see FIG. 1):
a host Operating System (OS) emulating the hardware components to one or several guest OS (only 2 guest OS are illustrated on FIG. 1).
one guest OS handling the general purpose tasks (eg: calendar, contacts, web browsing, phone communication, entertainment, etc) in an uncontrolled environment
one guest OS handling the interaction with the medical device in a controlled environment

Advantageously, the hOS is as thin as possible while integrating some advance operating processes and is in the lowest level operating system architecture. The host operating system isn't a simple hypervisor. Indeed, the host operating system further contains different security tasks and control tasks. Thus, the host operating system manages, coordinates the activities, shares the resources of the remote control and decides to deny and/or admit running application and/or using driver and/or peripherals of the remote control (3). In such a way the security is improved because a malicious software can't access any drivers and/or peripherals, such as but not limited to the MCU like described above.

Thus, by using this architecture, the controlled environment has always the full control of the remote control in order to prevent any malicious application either to intercept or to modify or to generate commands/information exchanged with the medical device. A typical action of such a malicious application would be to steal the PIN code of the user in order to mimic the programming of an infusion.

In one embodiment, this controlled environment is authenticated and its integrity is checked by means of an MCU as described above. At any boot of the Remote Control a safe check is done via said MCU, which shall confirm the integrity and authenticate the hOs and optionally the mOS.

In addition to this architecture, a specific monitoring program can be implemented to check all running tasks in the controlled environment, which can disable any application that is not within a specific list of authorized application. This specific monitoring can also be controlled by means of said MCU. Said monitor may also be able to measure the running time used by the application and indicate to the user any suspect overload of activity by triggering an alarm.

In one embodiment, said hOS is containing in and/or launching and/or running by said MCU.

In one embodiment, said mOS is containing in and/or launching and/or running by said MCU.

In one embodiment, said mOS and/or said hOS and/or hypervisor is containing in said MCU. When said MCU is inserted into the remote control, the MCU installs on the remote control said mOS and/or hOS and/or the virtual machine.

In one embodiment, the processing in the controlled environment can be signalled by using a visual indicator and/or audio indicator and/or other indicator (such as a vibrator), like a LED, which will signal to the user the fact that the current application is running in the controlled or not controlled environment. By example, we can imagine that a green LED will be switched ON when the current application is in the controlled environment and then, will be switched OFF when user returns in the not controlled environment. We could also have an “opposite” use case where the LED in OFF when user is in the controlled environment and becomes red when user returns in the uncontrolled environment.

In another embodiment, the hOS may reserve a part of the screen to the application running in controlled environment. In such a way, only the mOS can display something in this space and the application or other gOS, which is run in uncontrolled environment, can't use this space.

Thus, the user knows that the application of the mOS is running or not. Indeed, if said indicator doesn't inform the user correctly, it's certainly a malicious application which attempts to take the control of the medical device or attempts to mislead the user.

In one embodiment, the MCU comprises the list of the applications and/or software which can be running when the mOS is running. In one embodiment, with or without MCU, a PIN code allows to launch the mOS and/or medical device.

### Other Optional Features of the Medical Assembly

In another embodiment, the medical device comprises at least one sensor which may measure physiological properties of the patient, diagnostic means for recognizing in real time the first symptoms which are watched by said sensor and alarm means to alert the patient in case of said diagnostic means detect said first symptoms. In such way, the medical devices may monitor by the remote control and send alarm to a remote control.

In one embodiment, the remote control comprises a GPS for locating the user if the alarm is sent. Said medical assembly may launch an application in the remote control to locate the patient and to send said locating to a medical center or other person in case of said diagnostic means detect said first symptoms or/and if the patient can't do it himself. Also, said medical assembly may launch an application in the remote control to send data of physiological properties to a medical center or other person in case of said diagnostic means detect said first symptoms or/and if the patient can't do it himself.

The invention is of course not limited to the illustrated examples discussed previously.

1. A network node which communicates in a secure and wireless manner, said assembly comprising:
a. At least one medical node which comprises:
i. Communication means for communicating with a second node
ii. A memory which comprises at least one key information to establish and/or to communicate in a secure manner
b. A second node which comprises:
i. Communication means for communicating with the at least one medical node,
ii. At least one connecting means for connecting to at least one security token,
iii. Inputs means
iv. A CPU which is connected to said communication means, connecting means and inputs means,
c. Said at least one security token which comprises:
i. Connecting means for connecting to the second node
ii. A memory which comprises at least one key information to establish and/or to communicate in a secure manner
Wherein only one security token is paired with at least one medical node,
Wherein all or part of said key information is stored in a secure part of the memory of at least one medical node and in a secure part of the memory of the security token
Wherein no key information is exchanged by wireless communication.
Wherein said key information comprises the pairing data used to pair said nodes and/or at least one encryption key.

2. Assembly according to the claim 1, wherein said pairing data is the address of the at least one medical node, at least a partial link key, at least a partial long term key and/or at least a partial short term key.

3. Assembly according to the claim 2, wherein said pairing data is stored in a part of the memory of the security token which is readable by the second node.

4. Assembly according to the claim 1, wherein said at least one encryption key is asymmetric key or symmetric key.

5. Assembly according to the claim 2, wherein the memory of the token comprises a private key and the memory of the medical node comprises a public key associated.

6. Assembly according to the claim 2, wherein the memory of the medical node comprises a private key and the memory of the token comprises a public key associated.

7. Assembly according to the claim 1, wherein said at least one key information is shared between said at least one medical device and its security token and then said at least one key information is kept secretly in the memory of said at least one medical device and/or in the memory of the security token.

8. Assembly according to the claim 1, wherein the security token comprises a CPU.

9. Assembly according to claim 1, wherein the security token comprises a key generator.

10. Assembly according to claim 1, wherein said at least one encryption key is generated by the security token.

11. Assembly according to claim 8, wherein said at least one encryption key is transmitted to said at least one medical node by wired transmission.

12. Assembly according to claim 1, wherein said at least one medical node comprises connecting means for connecting to its security token in such a way that at least one medical node and its security token share at least one secret by wired transmission.

13. Assembly according to claim 10, comprising a pairing device which allows sharing at least one secret by wired transmission.

14. Assembly according to claim 1, wherein the private key is stored in a secure part of the security token in such a manner only the token is able to read and/or to use said private key.

15. Assembly according to claim 1, wherein the second node comprises an encryption engine.

16. Assembly according to the claim 8, wherein the security token transmits to the second node at least one encryption key.

17. Assembly according to the claim 1, wherein the second node (3) is a cell phone, a light remote control and/or a BGM or a link to a CGM.

18. Assembly according to claim 1, wherein the second node comprises at least one display means for displaying information to the user.

19. Assembly according to claim 16, wherein said at least one display means of the second node is a screen, a touchscreen and/or a LED.

20. Assembly according to claim 1, wherein the second node comprises at least one sensor means for monitoring blood glucose and/or physical activity of the user.

21. Assembly according to claim 1, wherein the second node comprises a connecting means for connecting a token which is not used with a medical node.

22. Assembly according to the claim 1, wherein the medical node is a delivery device, medical server, implantable device, a sampling device and/or sensor device

23. Assembly according to the claim 1, wherein the security token is a Smart card, Sim card, SD Card such as SDIO card (Secure Digital Input Output), an internal or external dongle

24. Assembly according to the claim 1, wherein at least one key information is the list of applications and/or software which can or not be run in the token and/or in the second node at a particular point of time.

25. Assembly according to the claim 1, wherein at least one key information is the data used to check the integrity of the application and/or the operating system and/or an upgrade version of medical application, at least during the boot.

26. Assembly according to the claim 1, wherein the second node uses a virtualization platform comprising:
a host operating system (hOS) emulating hardware components for at least one guest operating system (gOS),
a first gOS handling common functions such as but not limited to calendar or contacts, all those common functions being designed to be used in an uncontrolled environment,
a medical operating system (mOS) handling second node functions for a medical node, all those second node functions being designed to be used in a controlled environment.

27. Assembly according to the claim 12, wherein at least one key information is used to check the integrity of the hOS and/or mOS and/or gOS

28. Assembly according to the claim 12, wherein at least one key information is the list of applications and/or software which is used by the hOS to manage the priority.

29. Assembly according to the claim 1, wherein at least one key information is the address of the first node.

30. Assembly according to the claim 1, wherein at least one key information is the application and/or a specific operating system which will install in the second node.

31. Assembly according to the claim 1, wherein at least one key information is the identifier and/or the physical characteristics of the patient.

32. Assembly according to the claim 1, wherein the security token is plug into the second node or inserted in the second node or connected by wire or wireless means.

33. Assembly according to the claim 1, wherein the security token is an external dongle.

34. Assembly according to the claim 20, wherein the security token comprises inputs means, display means, activity sensor, fingerprint reader, wireless communication means or blood glucose meter.

35. Assembly according to the claim 21, wherein the wireless communication means of the security token allows connecting with the at least one medical node.

36. Assembly according to the claim 20, wherein the security token comprises connecting means for connecting another security token which is paired with another medical node.

37. Assembly according to the claim 1, wherein the second node comprises a memory in which at least one key information is at least temporarily stored.

38. Assembly according to the claim 37, wherein said at least one key information in memory of the second node is not usable if said security token is remove form said second node.

39. Assembly according to the claim 37, wherein said at least one key information, stored in the memory of the second node, is the list of applications and/or software which can or not be run in the token and/or in the second node at a particular point of time and/or the data used to check the integrity of the application and/or the operating system and/or an upgrade version of medical application, at least during the boot.

40. Assembly according to the claim 1, wherein the second node comprises other connecting means for connecting another security token which is paired with another medical node.

41. Assembly according to the claim 1, wherein said at least one medical node comprises encryption means for encrypting and/or decrypting said encrypted data;

42. Assembly according to any precedent claims, wherein the second node comprises encryption means for encrypting and/or decrypting said encrypted data, and wherein the said encryption key stored in the at least one security token is up-loaded in the second node by wire communication

43. Assembly according to the claim 1, wherein said at least one encryption key is kept secretly in the memory of at least one security token and wherein at least one security token comprises encryption means for encrypting and/or decrypting said encrypted data.

44. Assembly according to claim 1, wherein said at least one security token comprises processor in which is running a key generator which generates at least one encryption key.

45. Assembly according to claim 1, wherein said at least one medical node comprises processor in which is running a key generator which generates at least one encryption key.

46. A method to generate a session key to secure at least one communication between two distinct nodes, one of them comprising a token, said method comprising the following steps:
Providing two distinct nodes: 1 and 2. Said node 1 may comprise an encrypted key 1, a key generator and an encryption engine. Said node 2 comprises means for connecting to said token which may comprise an encrypted key 2, a key generator and an encryption engine.
Initialising a first communication by a first node
Generating a value V1 by the first node
Encrypting said value V1 with the key 1 (optional)
Transmitting said (encrypted) value V1 to the second node
Transmitting said (encrypted) value V1 to the token
Decrypting said value V1 with the key 2 (optional)
Generating a value V2 by the token
Computing a session key Ks1 by the token using the value V1 and V2
Encrypting said value V2 with the key 2 (optional)
Transmitting said (encrypted) value V2 to the second node
Transmitting said (encrypted) value V2 to the first node
Decrypting said value V2 with the key 1 (optional)
Computing a session key Ks2 by the first node using the value V1 and V2

47. Method according to the claim 31, wherein the session key Ks1 and Ks2 is equal and allow authenticating and exchanging encrypted data in secure manner.

48. Method according to claim 31, wherein the first node is the medical device or medical server and the second node is the remote control.

49. Method according to claim 31, wherein the token is a MCU, smart card, or SD card, or SIM card.

50. Method according to claim 31, wherein the encrypted keys are asymmetric or symmetric keys.

51. Method according to claim 35, wherein the encrypted key 1 is a public key and the encrypted key 2 is a private key.

52. Method according to claim 31, wherein the first node and/or the second node inform the patient that the communication is now performing in a secured manner by visual, sound indication or vibrator.

53. Process to share a secret between a node and its security token as disclosed above, the pairing process comprising the following steps:
Providing a token and a medical node
Providing a means for allowing a communication between said token and said medical node
Sharing at least one secret between the token and the medical node.

54. Process according to claim 38, wherein the means for allowing a communication between said token and said medical node is a pairing device.

55. Process according to claim 38, wherein said secret is generating by a generator included in the token.

56. Process according to claim 40, wherein said generator generates a private key which will be stored in the memory of the token and a public key associated sent to the medical node by wire connection.

57. Process according to claim 40, wherein said generator generates the pairing data to pair the medical node with another node which is connected to the token.

58. Pairing process of the assembly disclosed by the claim 1, said pairing process comprising the following steps:
Providing at least one medical node, a second node and at least one security token which is already paired with at least one medical node
Plugging at least one security token into said second node,
Using the pairing data contained in the memory of said security token and in the memory of at least one medical node to pair at least temporarily at least one medical node with said second node.

59. Loopback process between two distinct nodes, a security token and a user, the process comprising the following steps:
Receiving of a command sent by a second node to the first node
Storing said command in the memory of the first node
Encrypting said command by the first node using an encryption key A
Sending said encrypted command to the second node
Receiving said encrypted command by the second node
Sending said encrypted command to the security token
Receiving said encrypted command by the security token
Decrypting said encrypted command by the security token using an encryption key B
Displaying said command on the display means of the second node
Checking the command by the user
Validating by the user of said command using inputs means of the second node or of the security token (if it is an external CMU comprising inputs means such as a validation button)
Sending said validation to the first node to execute the command.

60. Process according to the claim 44, wherein said encryption key A and B is equal (symmetric key) or associated (asymmetric key).

61. Process according to the claim 44, further comprising challenge generating, secure means and/or status indication.

62. Process according to the claim 46, wherein the secure means is a PIN Code, symbols, pictures, words, forms which must be redrawn, entered or copied to validate the command.

63. Process according to the claim 46, wherein the secure means is fingerprint readers or fingerprint retinal.

64. Process according to the claim 44, wherein the security token comprises display means to display the command which will be validated.

65. Process according to the claim 44, wherein the security token comprises inputs means to validate the command.

66. Assembly according to the claim 13, wherein the second node is a cell phone comprises connecting means for connecting a SIM card of the cell operator and connecting means for connecting the security node.

67. Assembly according to the claim 51, wherein said second node is also a BGM or a link to a CGM.

68. Use an assembly disclosed by the claim 52, wherein the second node is useable as a cell phone if the SIM is connected to said second node.

69. Use an assembly disclosed by the claim 52, wherein the second node is useable as a remote control for managing the medical node if the security token is connected to said second node.

70. Use an assembly disclosed by the claim 52, wherein if the SIM Card and the security token are not connected to the second node, the second node is only usable as a BGM or a link to a CGM.

71. Use an assembly disclosed by the claim 52, wherein if the SIM Card and the security token are connected to the second node, the second node is usable as a BGM, cell phone and a remote control.
